(19) United States
(12) Patent Application Publication
(10) Pub. No.: US 2016/0024735 A1
(43) Pub. Date: Jan. 28, 2016

(54) Helical eel ramp

(71) Applicants: Eric P. Truebe, Candia, NH (US); Jonathan P. Truebe, Mirror Lake, NH (US)

(72) Inventors: Eric P. Truebe, Candia, NH (US); Jonathan P. Truebe, Mirror Lake, NH (US)

(21) Appl. No.: 14/806,704

(22) Filed: Jul. 23, 2015

Related U.S. Application Data
(60) Provisional application No. 62/028,249, filed on Jul. 23, 2014.

(51) Int. Cl. E02B 8/08; A01K 61/00

(52) U.S. Cl. CPC E02B 8/085; A01K 61/00

(57) ABSTRACT

A helical eel ramp spirals vertically with a plurality of turns and has a ramp surface with a ramp entrance on a bottom portion of the helical ramp, a ramp exit on a top portion of the helical ramp, a radial inner edge, and a radial outer edge. An outer barrier is connected along the radial outer edge of the helical and extends upward from the radial outer edge to retain liquid flow on the ramp surface. An inner barrier connected along the radial inner edge of the helical ramp also extends upward from the radial inner edge to retain liquid flow on the ramp surface. The ramp surface, outer barrier, and inner barrier define a channel configured to direct a liquid to flow from the ramp exit to the ramp entrance.

### BACKGROUND OF THE INVENTION

1. Field of the Invention

The present invention relates generally to ramps and fish ladders and more particularly to an eel ramp for upstream eel passage.

2. Description of the Prior Art

Dams and other obstructions placed into a waterway prevent the natural migration of fish and eels upstream for spawning and migration. Ramps positioned along river banks and at other locations have been used to allow eels to pass freely over dams or other obstructions which would otherwise hinder their upstream migration. Traditional eel ramps are installed at the base of the obstruction and use one or more sloped, longitudinal sections for the eels to comfortably climb up and over the obstruction. The need to maintain adequate water depth without excessive velocity, the geometry of the installation site, the goal of providing a comfortable climb for the eels, and other factors generally restrict the slope to about 45° or less. Known eel ramps have straight sections and may include one or more resting pools or turn pools between longitudinal sections. In addition to giving the eels a place to rest along long runs of the ramp, the turns or pools are useful for making the ramp fit into the available space at the desired location.

Eels are able to sense slope in addition to river currents for their migration. Ramps are installed with both transport water, which is sprayed onto the ramp, and attraction water, which is introduced at the base (entrance) of the ramp. The attraction water helps the eels find the entrance. The transport water allows eels to climb up the ramp and keep their bodies moist, since eels do not need to be submerged to move.

Another component of traditional eel ramps is a climbing substrate fixed to the ramp floor to help eels climb up the ramp. The climbing substrate allows an eel to achieve purchase with its body to ascend the pass by crawling as much as swimming. The climbing substrate can be stone, vegetation, or artificial materials. In some eel ramps, the climbing substrate is fish netting, polyethylene strands, a peg-style structure, or a mat with nylon bristles. The type of material used is correlated to the size of eel and slope of the ramp.

### SUMMARY OF THE INVENTION

In addition to other deficiencies, traditional eel ramps with straight sections require a lot of space for installation. In order to achieve the correct slope on a traditional eel ramp, the ramp must have long linear runs that extend along the obstruction or upstream along the bank of the waterway. The substantially fixed slope of these long runs is not inviting to eels of different sizes who prefer different slopes based on their length. Long, straight runs of the ramp also require structural support along the length, which is difficult, time consuming, and expensive to build and install due to the rough terrain along a river or dam. Further, eel theft and predators add additional design complications that add to the cost of eel ramps.

Traditional eel ramps are also subject to extreme river flows or dam spill as well as being exposed to snow and ice loading in winter. For this reason, traditional eel ramps often must be removed in winter to prevent damage. When a ramp is removed seasonally, adequate scheduling and management must be exercised for the ramp to be installed in time for eel migration.

Therefore, a need exists for an improved eel ramp that solves problems associated with traditional eel ramps. The present invention solves these deficiencies by providing an eel ramp with a helical pattern, rather than a series of straight ramps with turns. The footprint of a helical eel ramp is significantly reduced compared to a traditional ramp with straight sections. The reduced footprint of a helical eel ramp makes it possible to install the eel ramp in confined areas where a traditional ramp installation would be prohibitive. Also, a helical ramp oriented vertically is more easily supported from the dam structure or natural obstruction. Further, because the helical ramp has reduced exposure to the elements, it may be used year round.

Installing and maintaining a helical eel ramp is considerably safer than a traditional eel ramp. Since a helical eel ramp is set vertically, workers do not need to reach or reposition themselves along the length of the ramp as is necessary with longitudinal sections of traditional eel ramps. A helical eel ramp can be prefabricated in a shop, then either lowered to the installation site from above or tilted up from its base to a vertical position. Sections of a helical ramp may be stacked at the site to provide flexibility in assembling larger ramps and to reduce the weight of any one component of the ramp.

Due to the nature of a helicoid surface, a helical ramp has variations in slope along the radius of the ramp surface. This variation in slope appeals to eels of different sizes, whose climbing abilities and preferences vary.

In one embodiment, an eel ramp is a helical ramp that spirals vertically with a plurality of turns. The helical ramp has a ramp surface with a ramp entrance on a bottom portion, a ramp exit on a top portion, a radial inner edge, and a radial outer edge. An outer barrier is connected along the radial outer edge of the helical and extends upward from the radial outer edge to retain liquid flow on the ramp surface. An inner barrier connected along the radial inner edge of the helical ramp also extends upward from the radial inner edge to retain liquid flow on the ramp surface. The ramp surface, outer barrier, and inner barrier define a channel configured to direct a liquid to flow from the ramp exit to the ramp entrance.

In another embodiment, the helical ramp has a diameter in the range of about 1.5 to about 3 feet with a vertical rise of about 0.5 to about 1.5 feet per turn.

In some embodiments, a climbing substrate is affixed to the ramp surface. Alternately, other embodiments of the eel ramp have a textured ramp surface that may be used to distribute water flow across the width of the ramp surface and/or to assist eels in climbing up the eel ramp.

In another embodiment, the eel ramp has at least one support post attached to the helical ramp. For example, the support post is a central support post extending vertically and defining the solid inner barrier, where the helical ramp spirals along the central support post. In some embodiments, the helical ramp and/or the support post are made of metal.

In one embodiment, the helical ramp has a radius to the radial outer edge from about 9 to about 18 inches. In some embodiments, the helical ramp has a pitch of about 12 inches.

In some embodiments the ramp surface is like a helicoid and has a slope that increases from the radial outer edge to the radial inner edge. For example, the ramp surface has a minimum slope of 9 degrees at the radial outer edge and a maximum slope of 45 degrees at the radial inner edge. In some embodiments, the ramp surface has a slope of about 18 degrees at a midpoint between the radial inner edge and the radial outer edge.

In another embodiment, the helical ramp includes an exit receptacle with an outlet conduit, where the exit receptacle is positioned to receive eels from the ramp exit. A weir is connected between the ramp exit and the exit receptacle, where the weir has a sloped portion to direct eels from the ramp exit into the exit receptacle. In one embodiment, the sloped portion has a slope sufficient to preventing eels from climbing up the sloped portion.

In another embodiment, the helical ramp includes a water delivery system positioned to introduce water to one or more locations along the helical ramp. For example, the water delivery system introduces water to the ramp exit.

In another embodiment, the helical ramp includes one or more dams on the ramp surface. The dams extend radially between the radial inner edge and the radial outer edge. The dams are useful to distribute water flow across the radial width of the ramp surface.

In another embodiment, the helical ramp includes one or more resting pools in fluid communication with the ramp surface, where each resting pool is positioned between the ramp entrance and the ramp exit.

In another embodiment, the helical ramp includes a cover made of a flexible material and disposed to at least partially enclose the helical ramp. The cover in some embodiments encloses the helical ramp from the ramp entrance to the ramp exit. In some embodiments, the cover is made of 95% light-blocking cloth.

In another embodiment, the eel ramp includes a plurality of steps connected to the helical ramp and extending upward along one or more side of the helical ramp. For example, the steps comprise a staircase spiraling upward about the helical ramp. In another embodiment, one or more bridge is connected to the steps, such as a bridge extending from a top or bottom step to the obstruction or to land. In another embodiment, the steps extend upward along one side of the helical ramp in a linear arrangement similar to a ladder.

### BRIEF DESCRIPTION OF THE DRAWINGS

FIG. 1 is a perspective view of one embodiment of helical eel ramp of the present invention.

FIG. 2 is a front perspective view of an exit receptacle with weir and outlet pipe as illustrated in the embodiment of FIG. 1.

FIG. 3 is a rear perspective view of the exit receptacle of FIG. 2 shown without the back panel for clarity.

FIG. 4 is a perspective view of another embodiment of a helical eel ramp of the present invention shown installed adjacent an obstruction and including a set of steps and bridge.

FIG. 5 is a perspective view of another embodiment of a helical eel ramp of the present invention showing a resting pool disposed in fluid communication with the ramp surface and connected between adjacent sections of the helical ramp.

FIG. 6 is a perspective view of another embodiment of a helical eel ramp with adjacent sections offset from one another and connected by a longitudinal ramp.

FIG. 7 is a perspective view of another embodiment of a helical eel ramp of the present invention showing resting pools between vertically-adjacent sections of the ramp and including a shade cover disposed over the ramp.

### DETAILED DESCRIPTION OF THE PREFERRED EMBODIMENT

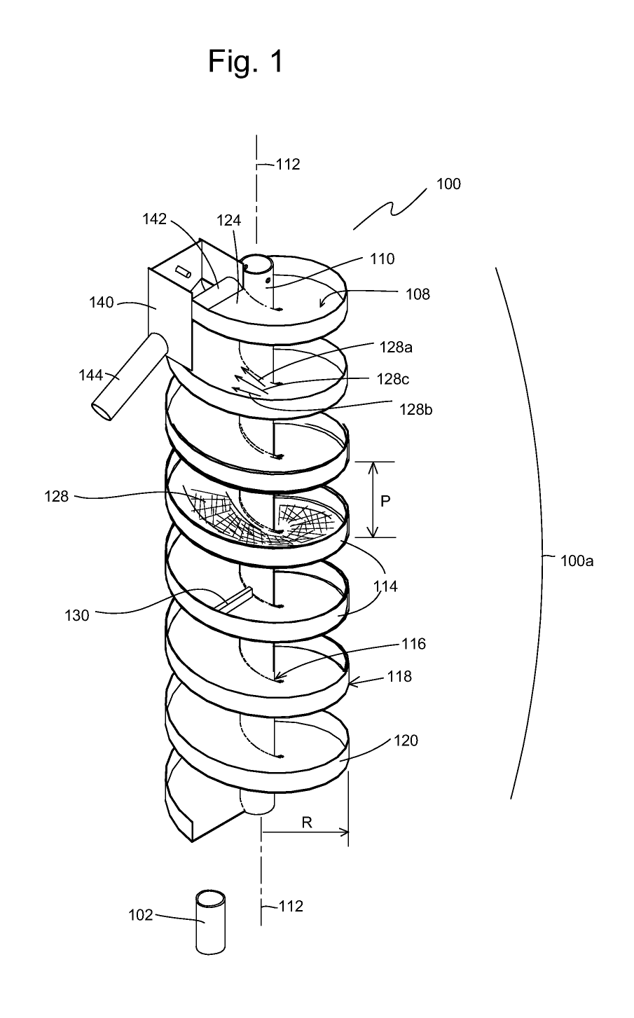

The preferred embodiment(s) of the present invention is illustrated in FIGS. 1-7. FIG. 1 shows a perspective view of one embodiment of a section 100a of an eel ramp 100 of the present invention. Eel ramp 100 includes a helicoid ramp surface 108 extending along and connected to a central support post 110 with axis 112. Eel ramp 100 generally resembles the helicoid of an Archimedes screw, where individual paths along ramp surface 108 follow a circular helix. Ramp surface 108 extends radially from a radial inner edge 116 to a radial outer edge 118. In some embodiments, the distance between radial inner edge 116 and radial outer edge 118 is about ten inches. The overall diameter of eel ramp 100 is preferably in the range of one and a half to three feet in diameter.

Two or more sections 100a may be stacked and connected together vertically to provide the desired height of eel ramp 100. In doing so, for example, ramp exit 124 of one section 100a aligns with and connects to ramp entrance 122 of an adjacent section 100a. A coupler 102 or the like may be used as needed to join support posts 110 of adjacent sections 110a. In one embodiment, each section 100a is about six feet tall when positioned vertically.

Ramp surface 108 has a plurality of turns 114 evenly distributed between ramp entrance 122 and ramp exit 124. Although the vertical rise between adjacent turns 114 may vary, it is typical to use a one foot rise between each adjacent turn when eel ramp diameter is in the range of 1.5 to 3 feet. Eel ramp 100 has a pitch P or vertical distance between adjacent turns 114 as the helix rotates 360°. Pitch P is about 12 inches in some embodiments, but may be larger or smaller depending on the radius R from axis 112 to radial outer edge 118.

A solid outer barrier 120 or wall extends upward (e.g., vertically) from radial outer edge 118 and configured to retain water and eels on eel ramp 100. Outer barrier 120 has a sufficient height to guide eels along eel ramp 100 and it is continuously connected to ramp surface 108 for directing water flow along its length. In one embodiment, outer barrier 120 has a wall height of about four inches. Outer barrier is continuously connected along radial outer edge 118 generally from a ramp entrance 122 at the bottom of eel ramp 100 to a ramp exit 124 at the top of eel ramp 100. In one embodiment, outer barrier 120 is made of a solid band of aluminum that is welded or otherwise connected along radial outer edge 118.

In some embodiments, ramp surface 108 extends upwardly along and connects to support post 110. Support post 110 provides structural support to eel ramp 100 and also forms an inner barrier along radial inner edge 116. Coupler 102 described above may optionally be formed in support post 110 such that one end of a support post 102 of an eel ramp section 100a nests into the opposite end of an adjacent eel ramp section 100a. In other embodiments, however, eel ramp 100 lacks a central support post 110 and instead has an inner barrier (not shown) similar to outer barrier 120, where the inner barrier is continuously connected along radial inner edge of ramp surface 108 between ramp entrance 122 and ramp exit 124. In such an embodiment, water is retained on and guided along ramp surface 108 due to outer barrier 120 and inner barrier (not shown). Structural support in such an embodiment may be provided by selecting appropriate materials of construction for ramp surface 108 and barriers 120. Structural support may also be provided by posts or support members (not shown) extending vertically along radial outer edge of ramp surface 108.

Ramp surface 108 is sloped upward relative to the horizontal. Consistent with a helicoid, the slope of ramp surface 108 increases from radial outer edge 118 to radial inner edge 116. In one embodiment, an inner slope 128a is no more than 45 degrees and an outer slope 128b is at least nine degrees. In one embodiment, a midpoint slope 128c (i.e., the slope at a point halfway between radial inner edge and radial outer edge) is about 18 degrees.

In some embodiments, one or more radially-extending dam structures 130 are affixed to ramp surface 108. Dam structure 130, when used on ramp surface 108 for water distribution, are typically oriented downwardly and inwardly toward radial inner edge 116. Dam structure 130 may also be used to retain annular or helical portions of climbing substrate 128, to provide an obstruction where water will pool, to distribute water flow across the width of the ramp surface, and/or to provide an additional surface against which eels may climb in which case the orientation of dam structures 130 would be modified according to its intended purpose. For increased pooling to occur, dam structure 130 extends between and attaches to support post 110 (or inner barrier) and outer barrier 120. In some embodiments, however, dam structure 130 does not extend fully across the width of ramp surface and/or are not attached at the ends of the dam structure to barriers along the ramp surface since such a dam structure will still create a localized area of pooled water to some extent or function to retain the position of climbing substrate 128. Dam structure 130 may be made of a solid material or may be made to allow water to flow through the dam, such as with a mesh or perforated sheet of metal.

In some embodiments of eel ramp 100, a climbing substrate 128 is adhered to ramp surface 108 to help eels climb eel ramp 100. In some embodiments, climbing substrate 128 is Enkamat®, a flexible three dimensional erosion-control polyamide mat made by Colbond in the Netherlands. This and other materials are useful as climbing substrate 128 for eels since they provide a textured surface eels may use to climb along ramp surface 108. Climbing substrate 128 may be adhered to ramp surface 108 using frictional force, an adhesive, fasteners, or other means. When dams 130 are present, climbing substrate 128 may be adhered by frictional engagement to ramp surface 108 and prevented from movement by dams 130. For example, one dam structure 130 on each turn 114 can be used to stabilize a piece of climbing substrate 128 that extends about 360° along ramp surface 108 to the next dam 130.

In other embodiments, climbing substrate 128 is not used. In still other embodiments, ramp surface 108 is sufficiently roughened or textured to provide purchase for eels to climb eel ramp 100. For example, ramp surface 108 has a pattern similar to aluminum diamond plate. In another embodiment, ramp surface 108 is finished so that the surface roughness is sufficient for eels to climb eel ramp 100.

Ramp exit 124 is positioned to direct eels over a weir 142 and into an exit receptacle 140 with an outlet 144. In some embodiments, climbing substrate 128 extends over weir 142. Upon reaching the ramp exit 124, eels climb over weir 142 and then fall or slide into exit receptacle 140 and pass through outlet 144 to a holding tank or to the waterway.

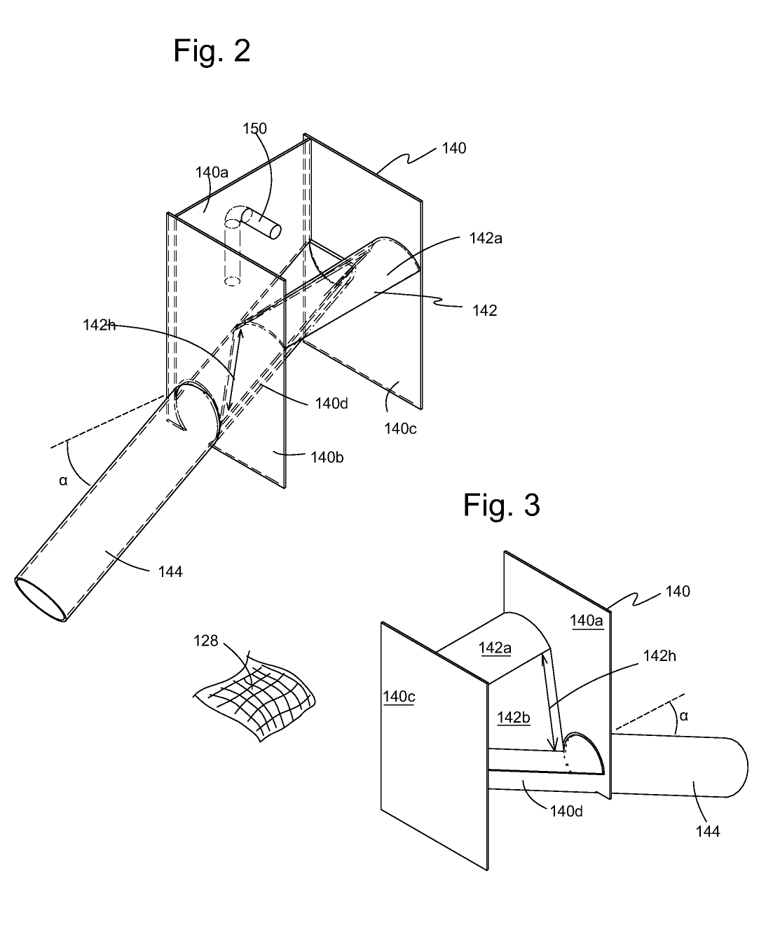

Referring now to FIGS. 2 and 3, front and rear perspective views, respectively, show exit receptacle 140 with outlet 144 and weir 142 as included with the embodiment of FIG. 1. In FIG. 3, rear wall 140a of exit receptacle 140 is not shown for clarity purposes. In a typical installation, eel ramp 100 is positioned with ramp exit 124 above the top of a structure the eels must overcome. However, the water level of the headwater leading to that structure does not always rise to the top of the structure, so eels exiting from eel ramp 100 will either drop to the water below or will need a way to get safely to the headwater. Since the height of the headwater may fluctuate and also may be a significant distance below ramp exit 124, some embodiments of eel ramp 100 include or are positioned with ramp exit 124 adjacent a weir 142 and exit receptacle 140 to safely direct the eels to the waterway.

In one embodiment, weir 142 has an upper portion 142a that attaches to or interfaces with ramp exit 124. Upper portion may be convex or slanted upward above ramp exit 124 to encourage eels to proceed due to the eels' ability to sense an incline and desire to continue upstream. In one embodiment, upper portion 142a is an upwardly convex metal member that connects continuously between ramp exit 124 and a downwardly-sloped portion 142b. Downwardly-sloped portion 142b is configured to direct eels into exit receptacle 140, sluice, or other destination such as the headwater. In one embodiment, downwardly-sloped portion 142b has a height 142h and a slope sufficient to prevent eels from climbing up and back over upper portion 142a to ramp exit 124.

In one embodiment, for example, weir 142 is made of aluminum or stainless steel and has a radius of curvature of about 1-2 inches, where upper portion arcs up above ramp exit 124 and connects continuously with downwardly-sloped portion 142b. Downwardly-sloped portion 142b has an incline greater than 45° to the horizontal and length greater than the length of eels who will use the eel ramp. For example, downwardly-sloped portion 142b is inclined about 60°-75° and has a length of at least four inches. After eels climb or swim over upper portion 142a, they slide down downwardly-sloped portion 142b and are directed into exit receptacle 140. The water flow rate, material finish, slope, length of downwardly-sloped portion 142b, and size of eels are considerations for determining the design of weir 142 so that eels cannot climb back over to ramp exit 124.

Exit receptacle 140 may be a small or large vessel that either holds eels or simply a larger opening to an outlet 144. In one embodiment, exit receptacle 140 has a substantially rectangular shape with side walls 140b, 140c and rear wall 140a, where side walls are spaced apart from each other and substantially parallel. In some embodiments, downwardly-sloped portion 142b is a front wall of exit receptacle 140; in other embodiments, downwardly-sloped portion 142b merely extends into exit receptacle. Rear wall 140a connects between side walls 140b, 140c and is spaced apart from and opposite of weir 142, which also connects between side walls 140b, 140c. Exit receptacle 140 has a bottom 140d connected to side walls 140b, 140c, rear wall 140a, and downwardly-sloped portion 142b of weir 142 to complete the vessel. In one embodiment, exit receptacle 140 is made of aluminum with side walls 140b, 140c connected to rear wall 140a, bottom 140d, and weir 142 by welding.

In one embodiment, bottom 140d is a channel or section of pipe that directs water and eels to outlet 144. In one embodiment, floor 140d is an open part of outlet 144, which may be a tube, pipe, channel, or other conduit that directs water and eels to the desired location. In one embodiment, outlet 144 is an aluminum tube with a diameter of three to four inches and extending from exit receptacle 140 at a downward angle α of about 30° to horizontal.

In some embodiments, exit receptacle 140 includes a spray nozzle 150 positioned to deliver water to weir 142 and/or exit receptacle 140. Other water delivery systems are acceptable. In one embodiment, spray nozzle 150 is attached to or extends through rear wall 140a and delivers water in a range of approximately 5 gallons per minute to about 10 gallons per minute onto upper portion 142a of weir 142, some of which flows down ramp surface 108 and some of which flows into exit receptacle 140 and out through outlet 144. Additional spray nozzles optionally are positioned along eel ramp 100 to provide additional water flow at desired locations. In contrast, adjacent to the entrance of eel ramp 100, a water flow rate of 50 gallons per minute is typically used in the pool in which the entrance is located to attract the eels toward the entrance of eel ramp 100. The pool diameter will typically always be larger than eel ramp diameter. For example, if eel ramp 100 has a diameter of two feet, then the pool will have a typical diameter of at least three feet.

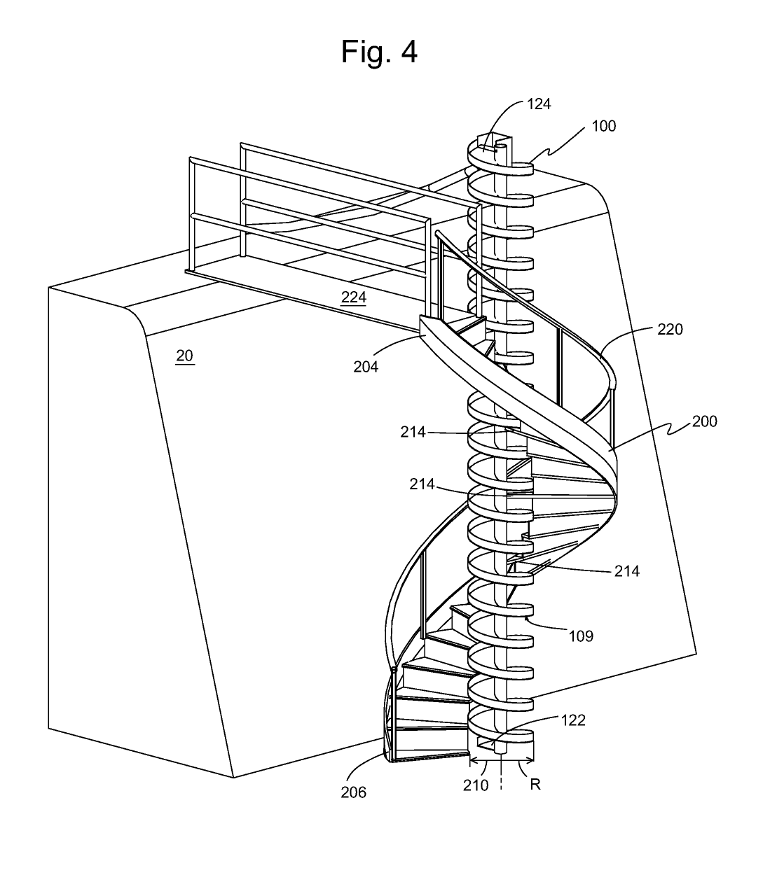

Referring now to FIG. 4, a perspective view shows another embodiment of eel ramp 100 installed adjacent a dam 20. This embodiment includes optional steps 200 attached to or configured to attach to eel ramp 100. In some embodiments, steps 200 are arranged similar to a ladder that extends upward along a side of eel ramp 100. In other embodiments, steps 200 are configured as a spiral staircase that spirals along and connects to eel ramp 100.

For example, steps 200 are arranged in a spiral staircase having an inside step radius 210 equal to radius R of eel ramp 100, where steps 200 can be attached to eel ramp 100. Steps 200 attach to outer barrier 120 or other locations on eel ramp 100. In other embodiments, one or more tread supports 214 extend horizontally to attach to central support post 110, such as between adjacent turns 114 of eel ramp 100 or along a bottom face 109 of ramp surface 108. In some embodiments, central support post 110 serves as the structural support both for eel ramp 100 and for steps 200. In other embodiments, steps 200 provide the structural support to eel ramp 100.

As shown in FIG. 4, steps 200 optionally include a handrail 220 offset vertically from an outside edge of steps 200 and extending along the path of steps 200. In some embodiments, steps 200 optionally include a bridge 224 extending between an upper stairway portion 204 and an obstruction 20 or other structure. Similarly, steps 200 may also or alternately include bridge 224 connecting to lower stairway portion 206 and extending to land or other location. Since eel ramp 100 is often installed with ramp entrance 122 located in a pool of water and ramp exit elevated beyond the reach of a person standing at the base of the ramp, steps 200 and any bridge(s) 224 facilitate a worker's access to the entire eel ramp 100 for maintenance and inspection. Compared to traditional eel ramps that need multiple sets of steps, ladders, or other means of access, eel ramp 100 equipped with steps 200, such as a spiral staircase, significantly reduces the cost of and increases the ease of worker access to eel ramp 100 for maintenance.

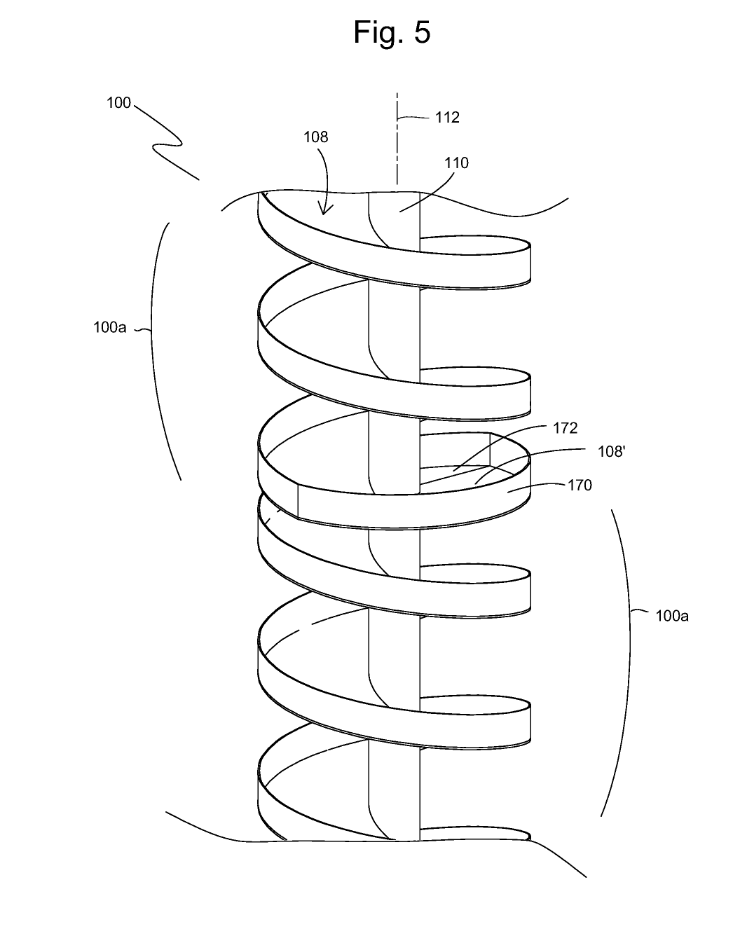

Referring now to FIG. 5, a portion of another embodiment of eel ramp 100 is illustrated with an optional resting pool 170. In some embodiments, for example, where multiple sections 100a are joined together to define eel ramp 100 of the desired height, one or more resting pools 170 may be used to provide a location for eels to rest along their journey to ramp exit 124 (shown in FIG. 1). For example, a resting pool 170 is connected between sections 100a of eel ramp 100 that are aligned vertically along a single axis 112. Resting pool 170 in one embodiment is a section with a diameter and construction similar to that of ramp 100 and having a substantially flat (rather than inclined) ramp surface 108′. For example, resting pool 170 extends about 180° and connects between adjacent sections 100a. Resting pool may be larger or smaller. Ramp surface 108 of eel ramp 100 is continuous with ramp surface 108 of resting pool 170, where the helical path of ramp surface 108 includes an entrance 172 into resting pool 170 from ramp surface 108.

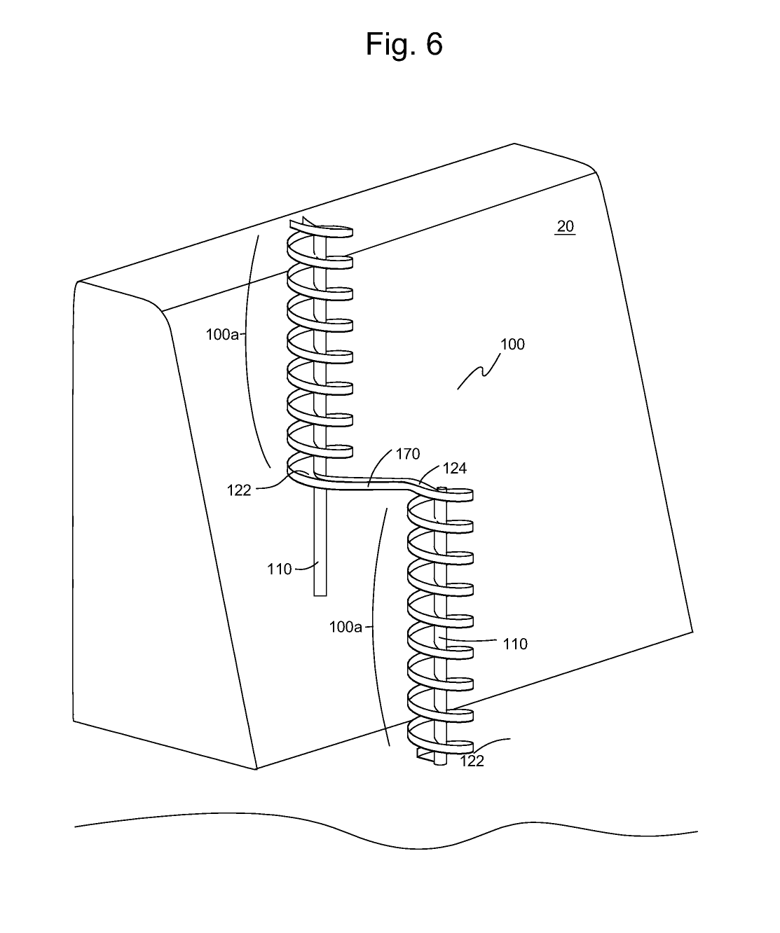

Referring now to FIG. 6, in other embodiments, adjacent sections 100a of eel ramp 100 are spaced laterally from each other and each section 100a has its own support post 110. In such embodiments, resting pool 170 may be disposed between ramp exit 124 of one section 100a and ramp entrance 122 of another section 100a and shaped as needed. For example, adjacent sections 100a are positioned along a sloped surface of obstruction 20, where resting pool 170 is a straight or curved ramp connecting the sections 100a and has little or no incline along resting pool 170. For example, resting pool 170 has an incline of less than 9°.

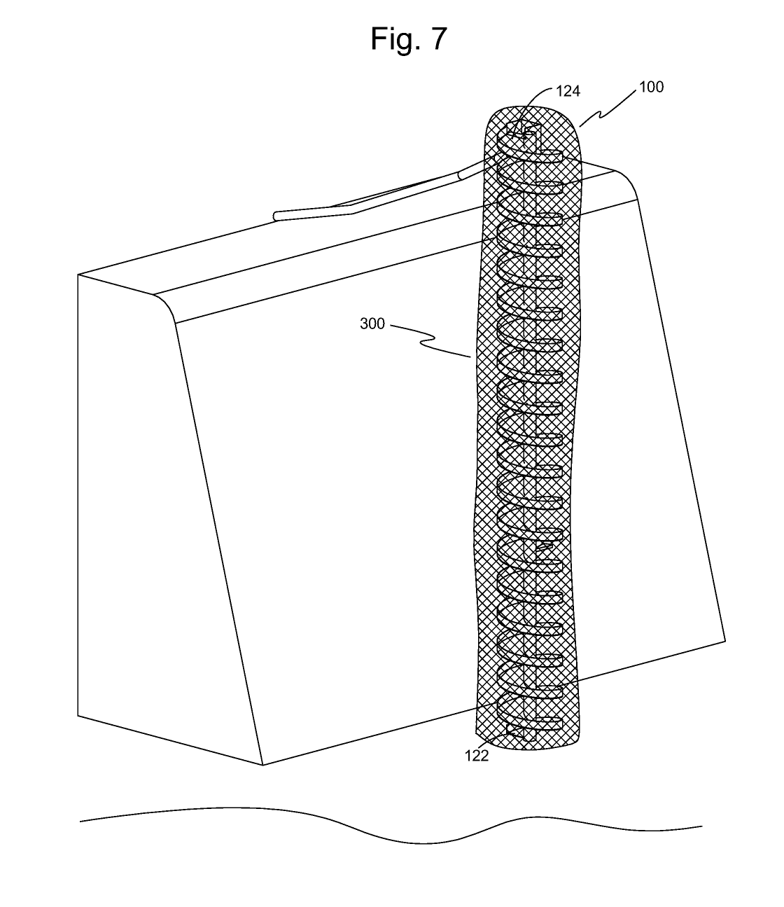

Referring now to FIG. 7, another embodiment of eel ramp 100 is shown with an optional cover 300. To protect eels from predators and light, eel ramp 100 is optionally enclosed or covered by cover 300. Cover may partially or complete enclose eel ramp 100. Since some eels only migrate upstream at night, night lighting impinging on eel ramp 100 may impede the progress of eel migration. Cover 300 also protects eels from predators as they ascend eel ramp 100. In one embodiment, cover 300 is 95% light-blocking shade cloth that covers eel ramp 100 substantially from ramp entrance 122 to ramp exit 124.

In use, eel ramps 100 of the present invention are used to facilitate upstream migration over an obstruction for eels and other animals. Multiple sections 100a may be assembled together on site for an eel ramp 100 of the desired height.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

We claim:

1. An eel ramp comprising:
a helical ramp spiraling vertically with a plurality of turns and having a ramp surface with a ramp entrance on a bottom portion of the helical ramp, a ramp exit on a top portion of the helical ramp, a radial inner edge, and a radial outer edge wherein the helical ramp has a diameter in the range of about 1.5 to about 3 feet;
an outer barrier connected along the radial outer edge of the helical ramp between the ramp entrance and the ramp exit, the outer barrier extending upward from the radial outer edge and configured to retain liquid flow on the ramp surface; and
an inner barrier connected along the radial inner edge of the helical ramp between the ramp entrance and the ramp exit, the inner barrier extending upward from the radial inner edge and configured to retain liquid flow on the ramp surface;
wherein the ramp surface, outer barrier, and inner barrier define a channel configured to direct a liquid to flow from the ramp exit to the ramp entrance.

2. The eel ramp of claim 1 further comprising a climbing substrate disposed onto the ramp surface.

3. The eel ramp of claim 1 wherein the ramp surface is textured.

4. The eel ramp of claim 1 further comprising at least one support post attached to the helical ramp.

5. The eel ramp of claim 4, wherein the at least one support post is a central support post extending vertically and defining the solid inner barrier, wherein the helical ramp spirals along the central support post.

6. The eel ramp of claim 1, wherein a radius to the radial outer edge is from about 9 to about 18 inches.

7. The eel ramp of claim 6, wherein the helical ramp has a pitch of about 12 inches.

8. The eel ramp of claim 1, wherein the ramp surface has a slope that increases from the radial outer edge to the radial inner edge.

9. The eel ramp of claim 8, wherein the ramp surface has a minimum slope of 9 degrees at the radial outer edge and a maximum slope of 45 degrees at the radial inner edge.

10. The eel ramp of claim 8, wherein the ramp surface has a slope of about 18 degrees at a midpoint between the radial inner edge and the radial outer edge.

11. The eel ramp of claim 1 further comprising:
a exit receptacle with an outlet conduit, wherein the exit receptacle is positioned to receive eels from the ramp exit; and
a weir connected between the ramp exit and the exit receptacle, wherein the weir has a sloped portion to direct eels from the ramp exit into the exit receptacle, the sloped portion having a slope sufficient to preventing eels from climbing up the lower portion.

12. The eel ramp of claim 1 further comprising a water delivery system positioned to introduce water to one or more locations along the helical ramp.

13. The eel ramp of claim 12, wherein the water delivery system introduces water to the ramp exit.

14. The eel ramp of claim 1 further comprising one or more dams on the ramp surface and extending radially between the radial inner edge and the radial outer edge.

15. The eel ramp of claim 1 further comprising one or more resting pools in fluid communication with the channel, the one or more resting pools positioned between the ramp exit of one eel ramp and the ramp entrance of an adjacent eel ramp.

16. The eel ramp of claim 1 further comprising a plurality of steps connected to the helical ramp and extending upward along one or more sides of the helical ramp.

17. The eel ramp of claim 16, wherein the plurality of steps comprises a staircase spiraling upward about the helical ramp.

18. The eel ramp of claim 16 further comprising one or more bridge connected to the plurality of steps.

19. The eel ramp of claim 1 further comprising a cover made of a flexible material and disposed to at least partially enclose the helical ramp.

20. The eel ramp of claim 19, wherein the cover is made of 95% light-blocking material.
